(19) United States
(12) Patent Application Publication
(10) Pub. No.: US 2004/0095235 A1
(43) Pub. Date: May 20, 2004

(54) Braking warning indicator

(76) Inventor: Chih-An Hsu, Kaohsiung City (TW)

Correspondence Address: Leong C. LEI, PMB #1008, 1867 Ygnacio Valley Road, WALNUT CREEK, CA, 94598-3214, US

(21) Appl. No.: 10/294,568

(22) Filed: Nov. 15, 2002

(51) Int. Cl. B60Q 1/44

(52) U.S. Cl. 340/479

(57) ABSTRACT

A braking warning indicator is disclosed. The indicator comprises a housing, a signal receiving device, light bulb, batteries and a bottom cover characterized in that the housing is an elongated semi-circular frame body having a circular arch-shaped wall provided with a plurality of outward extended semi-circular protrusions, the two sides of the housing is provided with a pressing protruded block for a flash switch and power, and the bottom cover is an elongated frame body corresponding to the housing, and the middle of the housing is a cavity for the signal-receiving device, and the two sides of the cavity are provided with through holes for the batteries. The housing and the bottom cover are made from soft plastic materials which can be fabricated in accordance with the edge or curvature of a helmet or the housing of a vehicle.

### BACKGROUND OF THE INVENTION

(a) Technical Field of the Invention

The present invention relates to braking warning indicator, and in particular, the structure of an indicator which can be mounted onto the surface on curvature of a helmet or the housing of a vehicle so that the indicator is lighted when the brake is applied.

(b) Description of the Prior Art

Taiwanese Patent Publication Nos. 374297 and 361107 disclose the function of a third braking light of a vehicle, wherein wireless signal is applied to provide the function of braking indication.

In a conventional braking warning light, an indicator is mounted onto the helmet so that when the driver brakes a vehicle, braking signal is triggered and is transmitted to a signal receiving device on the helmet. As a result, the indicator on the helmet is lighted to provide a braking warning. As shown in FIG. 1, the indicator is a light seat having a hard housing and therefore the length is short and is limited in order to adhere onto the surface of the helmet. In this conventional structure, three LED bulbs can be mounted on the bulb seat and the remaining space is for the mounting of batteries and the signal receiving device. Due to the low brightness of the LED light bulbs, the effect of warning indication is limited. Further, the light source is diffused in a flat plan, therefore, the brightness is insufficient to function as a warning indicator. In view of the above, it is an object of the present invention to provide a braking warning indicator which mitigates the above drawbacks and at the same time, provides a bright warning indication such that the braking warning is produced when the brake of the vehicle is applied.

### SUMMARY OF THE INVENTION

An aspect of the present invention is to provide a braking warning indicator having a housing, a signal receiving device, light bulb, batteries and a bottom cover characterized in that the housing is an elongated semi-circular frame body having a circular arch-shaped wall provided with a plurality of outward extended semi-circular protrusions, the two sides of the housing is provided with a pressing protruded block for a flash switch and power, and the bottom cover is an elongated frame body corresponding to the housing, and the middle of the housing is a cavity for the signal-receiving device, and the two sides of the cavity are provided with through holes for the batteries.

Yet another object of the present invention is to provide a braking warning indicator, wherein the housing is made from a soft plastic material so that the housing can be mounted on the surface or the curvature of the helmet and thus the range of safety warning is increased.

A further object of the present invention is to provide a braking warning indicator, wherein the center of the housing is provided with protrusions and the light of the LED can pass through the protrusions and the brightness of the light is amplified to provide an easily seen warning indication.

Yet another object of the present invention is to provide a braking warning indicator, wherein the warning indicator can be mounted onto any place on the vehicle or on the triangular shape warming indication board so as to provide warning when the vehicle is stopped.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional warning indicator.

FIG. 2 is a perspective view of a braking warning indicator in accordance with the present invention.

FIG. 3 is an exploded perspective view of FIG. 2 in accordance with the present invention. FIG. 4 is a perspective view of FIG. 2 when the indicator is lighted in accordance with the present invention.

FIGS. 5, 6 and 7 show the application of the indicator as shown in FIG. 2.

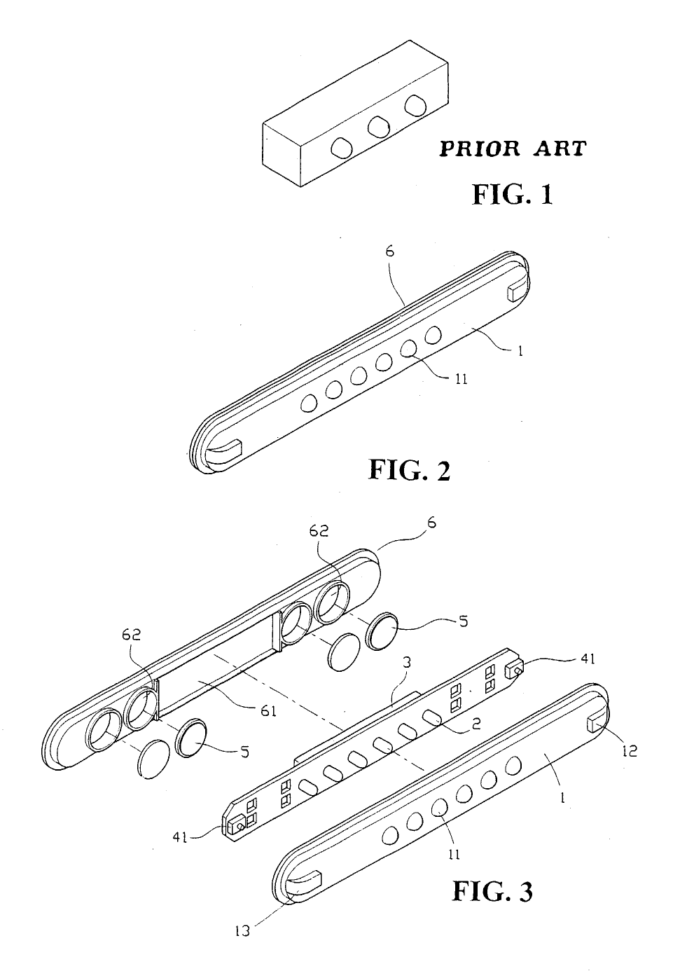

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIG. 2, in accordance with the present invention, there is shown a braking warning indicator which can be made into an elongated shape so as to mount a plurality of LED light bulbs. The indicator has a housing 1 and the center of the housing is provided with a plurality of protruded semi-circular protrusions and these protrusions are made from transparent plastic material, which can transmit light from the LED light bulbs. The indicator has a bottom cover 6 which is provided with double-sided tape to adhere the indicator onto the helmet or the vehicle.

Referring to FIG. 3, the braking warning indicator essentially comprises a housing 1, light bulb 2, a signal-receiving device 3, switches 41, 42, batteries 5 and a bottom cover 6. The housing 1 is an elongated body having a hollow center provided with a plurality of outward extended protrusions 11, and the end head of the two sides of the housing 1 is provided with protruded pressing protruded blocks 12, 13 and the bottom face thereof is a flat opening. The light bulbs 2 are LEDS with high brightness and are mounted to the circuit base board 31 connecting the signal-receiving device 3. The bottom cover 6 is an elongated body corresponding to the housing having a cavity 61 at the center thereof so as to receive the signal-receiving device. The two lateral sides of the cavity 61 are provided with through holes 62, allowing the mounting of batteries 5 from the exterior of the bottom cover.

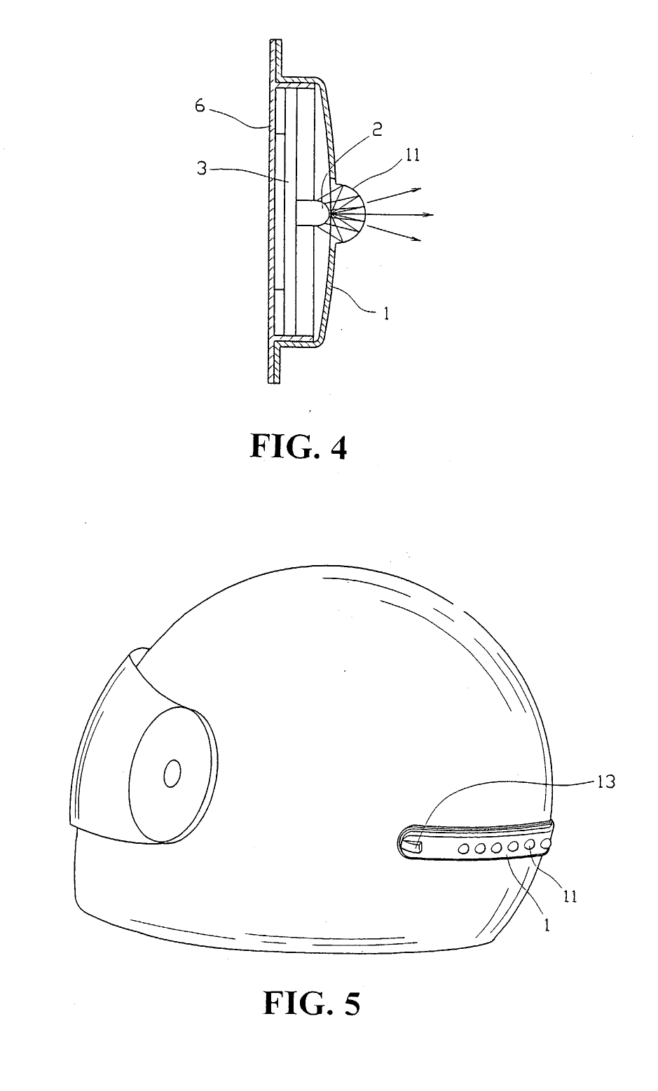

In accordance with the present invention, in order to increase the number of LED light bulbs and to widen the brightness of the light bulbs, the housing is made into elongated shape and is made from soft plastic material, for instance, by plastic molding. The elongated warning indicator can be mounted onto the curvature of the helmet, as shown in FIG. 5. Thus, the warning indication of the present indicator provides vision to vehicle from the rear and from the front.

The flashing from the sides of the indicator can also be seen. Further, by employing the protrusions at the middle section of the housing, the protruded shape of the housing can focus light rays of the LED light bulbs at the end point of the circular arch, and therefore the brightness of the light source is increased. If high brightness LED light bulbs are used, the indicator at 200 m away can be seen. Thus, the indicator provides a safety in the course of driving a vehicle.

The two sides of the bottom cover 6 are provided with batteries mounting hole 62. A double-sided tape is used to adhere the indicator of the present invention onto a helmet. By connecting the control of the signal transmitting device of the braking warning indicator of the vehicle, the brightness of the LED light bulbs can achieve the objective of braking warning indicator. The two sides of the housing are provided with a power source switch and pressing switches 41, 42 for intermittent flashing. If the vehicle is stopped at the road side, the helmet can be placed on the vehicle, and the pressing button of the power source and the intermittent flashing are pressed. Then the indicator will flash to provide warning. If the batteries are exhausted, new batteries can be replaced.

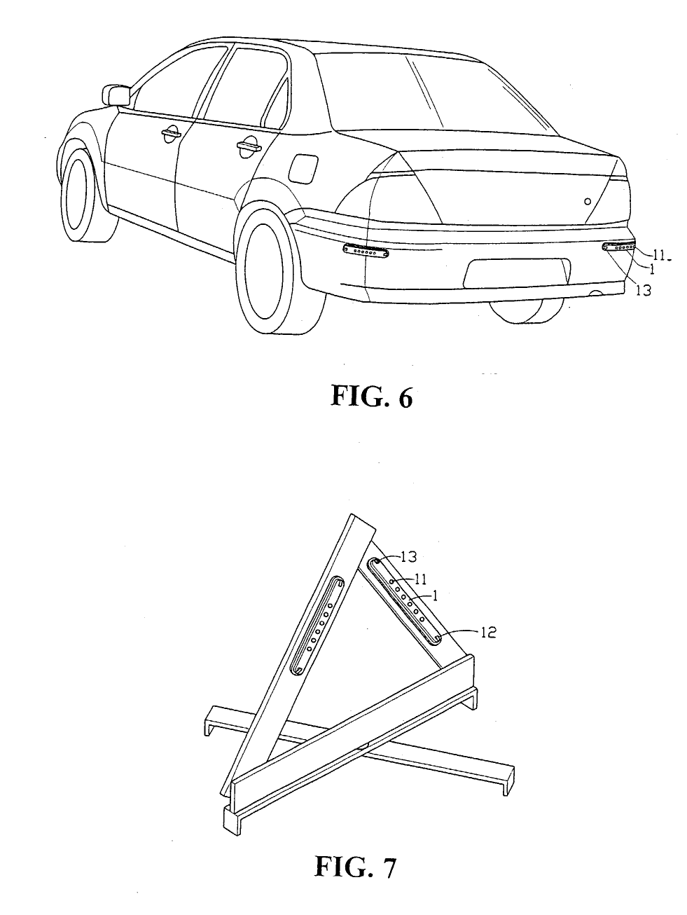

In another preferred embodiment of the present invention, the indicator can be mounted onto the sides of the rear side of the vehicle, as shown in FIG. 6, the indicator can be mounted in accordance with the profile of the vehicle surface. The curvature of the surface will not affect the mounting of the indicator. Thus, to drives drive at a great speed, the warning indication will provide a warning. The indicator of the present invention can also adhere to the triangular shape warning board.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A braking warning indicator having a housing, a signal receiving device, light bulb, batteries and a bottom cover characterized in that the housing is an elongated semi-circular frame body having a circular arch-shaped wall provided with a plurality of outward extended semi-circular protrusions, the two sides of the housing is provided with a pressing protruded block for a flash switch and power, and the bottom cover is an elongated frame body corresponding to the housing, and the middle of the housing is a cavity for the signal-receiving device, and the two sides of the cavity are provided with through holes for the batteries.
